(19) United States
(12) Patent Application Publication
(10) Pub. No.: US 2011/0042210 A1
(43) Pub. Date: Feb. 24, 2011

(54) METHOD FOR PREPARING METAL NANOPARTICLES USING METAL SEED AND METAL NANOPARTICLES COMPRISING METAL SEED

(75) Inventors: Sung Koo KANG, Suwon-si (KR); Hyunjoon Song, Daejeon (KR); Daeha Seo, Busan (KR); Jongwook Jung, Daegu (KR); Garam Park, Seoul (KR); Donghoon Kim, Seongnam-si (KR); KwiJong Lee, Suwon-si (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 12/649,972

(22) Filed: Dec. 30, 2009

(30) Foreign Application Priority Data
Aug. 19, 2009 (KR) 10-2009-0076845

(51) Int. Cl. G01N 27/26; C22C 5/02; B22F 9/16; C09D 11/00

(52) U.S. Cl. 204/403.01; 420/510; 75/351; 106/31.13; 977/773

(57) ABSTRACT

The invention relates to a method of manufacturing metal nanoparticles by using metal seed and metal nanoparticles including such metal seed. It is to provide the Au nanoparticles prepared by a method comprising: preparing a solution by adding a monosurfactant into a non-aqueous solvent; heating the solution; preparing a platinum seed solution by adding platinum salt chosen form platinum, palladium, iridium into the heated solution; and adding gold salt in the platinum seed solution.

### CROSS-REFERENCE TO RELATED APPLICATIONS

This application claims the benefit of Korean Patent Application No. 10-2009-0076845 filed on Aug. 19, 2009, with the Korea Intellectual Property Office, the contents of which are incorporated here by reference in their entirety.

### BACKGROUND

1. Technical Field

It relates to a method for manufacturing metal nanoparticles by using a metal seed and metal nanoparticles including a metal seed.

2. Description of the Related Art

Au nanoparticles have been generally manufactured by various methods such as a chemical synthetic method, a mechanical method and electrical method. The mechanical method uses mechanical power to grind particles but it is difficult to obtain pure nanoparticles due to impurities mixed during the process and impossible to obtain uniform nanoparticles. The electrical method using electrolysis requires a long manufacturing period and results in low concentration and poor efficiency. The chemical synthetic method can be divided to a vapor phase method and a liquid phase method. Since the vapor phase method using plasma and vaporization requires costly equipment, the liquid phase method, which allows the formation of uniform nanoparticles at low manufacturing cost, has been generally widely used.

The most well known method for manufacturing Au nanoparticles using the liquid phase method is a method manufacturing in a non-aqueous condition using organic thiol as a surfactant. This method provides uniform Au nanoparticles without any limitation of concentration but it requires using costly or environmentally unfriendly reducing agent and phase-change materials. Particularly, it is difficult to remove the organic thiol molecule from the surface of particles so that it cannot be suitable for conductive inks.

On the other hand, some typical method known as aqueous manufacturing method are a hydrogen tetrachloroaurate (HAuCl₄) reduction using citric acid in water, a hydrogen tetrachloroaurate reduction using sodium borohydride (NaBH₄) and so on to manufacture uniform nanoparticles in simple process. However, its manufacturing concentration is not high enough for mass production. When mass production is performed, dispersion stability is significantly reduced in a high concentration of solution.

Another method for manufacturing Au nanoparticles using an external energy such as UV, NIR, ultrasonic wave, and micro wave, except these methods, has been also introduced but it has drawbacks such as manufacturing concentration, manufacturing scale, and un-uniform energy delivery which are still left as problems to be solved.

Further, metal materials are deposited in a reactor during a curing process which causes poor manufacturing yield.

### SUMMARY

The invention is to allow excellent dispersion in a high concentration in mass production of metal nanoparticles and high yield by preventing precipitation of metal materials by conducting a curing process at a low temperature.

For this purpose, it provides Au nanoparticles including 0.001-50 mol % of a platinum seed with respect to the total particles in which the Au nanoparticles is grown from the platinum seed produced in a non-aqueous solvent.

It provides Au nanoparticles including 0.1-20 mol % mol % of a platinum seed with respect to the total particles in which the Au nanoparticles is grown from the platinum seed produced in a non-aqueous solvent.

According to an aspect of the invention, there is provided Au nanoparticles manufactured by a method including: preparing a solution by adding a monosurfactant into a non-aqueous solvent; preparing a platinum seed solution by adding platinum salt into the solution; and adding gold salt in the platinum seed solution.

According to another aspect of the invention, there is provided a method for manufacturing Au nanoparticles including: preparing a solution by adding a monosurfactant into a non-aqueous solvent; forming platinum seeds by adding platinum salt into the solution; and adding gold salt in the solution containing platinum seeds.

According to an embodiment, the non-aqueous solvent may be at least one chosen from toluene, benzene, chlorobenzene, dichlorobenzene, xylene and a mixture thereof.

According to an embodiment, the monosurfactant may be added by 10-50 equivalents per 1 equivalent of the gold salt and the platinum salt to form the platinum seed may be added by 1/5-1/100 equivalents per 1 equivalent of the gold salt

According to an embodiment, the monosurfactant may be a C8-C20 amine.

According to an embodiment, the monosurfactant may be chosen from octylamine, dodecylamine, and oleylamine.

According to an embodiment, the platinum salt may be chosen from chloroplatinic acid(H₂PtCl₆), and platinum chloride(PtCl₄).

According to an embodiment, the gold salt may be chosen from gold chloride(AuCl₃), hydrogen tetrachloroaurate(HAuCl₄), hydrogen tetrabromoaurate(HAuBr₄) and gold acetylacetonate.

The platinum seed solution may be reacted at 25-50° C. for 5 mins to 2 hrs after adding the platinum salt.

The Au nanoparticles after adding the gold salt may be reacted at 25-50° C. for 1 min to 2 hrs.

According to an embodiment, there is provided a nano colloid solution including Au nanoparticles.

According to an embodiment, there is provided nano ink including Au nanoparticles.

According to an embodiment, there is provided an interconnection pad including Au nanoparticles.

According to an embodiment, there is provided a biosensor including Au nanoparticles.

### BRIEF DESCRIPTION OF DRAWINGS

FIG. 1 is a TEM image of Au nanoparticles prepared according to Example 1

FIG. 2 is a TEM image of Au nanoparticles prepared according to Example 2.

FIG. 3 is a TEM image of Au nanoparticles prepared according to Example 3

### DETAILED DESCRIPTION

The method for manufacturing metal nanoparticles and the metal nanoparticles manufactured thereby will be described in detail hereinafter.

Au particles may be manufactured by using hydrogen tetrachloroaurate as a gold salt, a non-aqueous solvent such as toluene, and an organic amine such as dodecylamine and octylamine as a surfactant. In order to reduce a size of Au nanoparticles and increase dispersion, platinum seed may be used as a precursor before the gold salt is added. The platinum seed is produced by reacting with tetrabuthylammonium borohydride as a reducing agent and final Au nanoparticles are produced by reacting the result with hydrazine as a reducing agent after adding hydrogen tetrachloroaurate. Several nano sized-nanoparticles having unstable platinum seeds on the surface, which are prepared at room temperature, may accelerate the reduction of the gold salt. Such accelerated reduction due to the platinum seed may play a key role in manufacturing Au nanoparticles.

In a particular method for manufacturing Au nanoparticles, an optimal condition for manufacturing Au nanoparticles may be using 2.46×10⁻⁴ mol of hydrogen tetrachloroaurate (HAuCl₄) and gold chloride (AuCl₃) as a gold salt, 925 mg of dodecylamine as a surfactant, and 25 mL of toluene as a solvent. Further, 2.46×10⁻⁵ mol of chloroplatinic acid (H₂PtCl₆) or platinum chloride (PtCl₄) may be used as a precursor of platinum seed, in which a ratio of platinum salt and gold salt may be 10 mol %. Tetrabuthylammonium borohydride may be used as a reducing agent to produce the platinum seed and hydrazine may be used as a reducing agent to make Au nanoparticles grow.

Hereinafter, although more detailed descriptions will be given by examples, those are only for explanation and there is no intention to limit the invention.

### Example 1

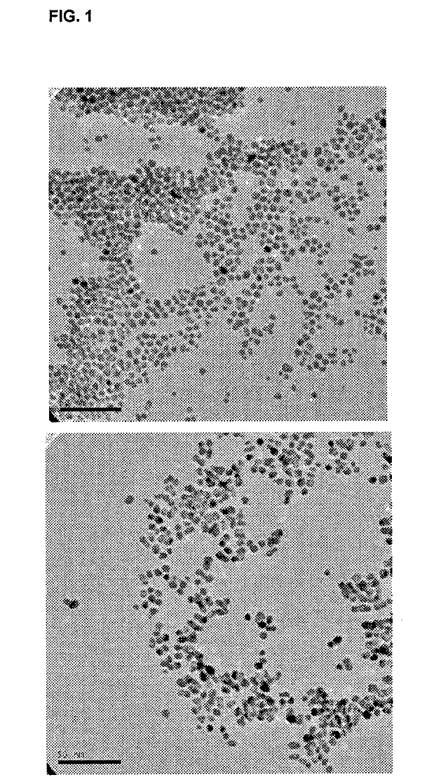

8.5 mg of platinum chloride and 186 mg of dodecylamine were added into 3.5 mL of toluene and a mixed solution was stirred at room temperature. When platinum chloride was melt completely, 25 mg of tetrabuthylammonium borohydride of a reducing agent and 18.6 mg of dodecylamine were dissolved in 1 ml of toluene and this mixed solution was added into the platinum solution. Within about 30 mins after adding the reducing agent, the solution turned to a clear black color which was indication of the production of the platinum seed. Such produced platinum seed was stable even after 24 hours and dispersed in a solution. 2.46×10⁻⁴ mol (97 mg of HAuCl₄) of gold salt and 826 μl of octylamine (Example 1a) [413 μl of octylamine and 323 μl of triethylamine (Example 1b)] dissolved in 25 mL of toluene was added into the platinum seed solution. 0.20 M of hydrazine was finally added to grow up to Au nanoparticles. The final solution was dark purple color which was indication of the production of Au nanoparticles stably. As shown in a TEM image of Au nanoparticles, it is noted that Au nanoparticles having a size of less than 10 nm are prepared stably (FIG. 1, 50 nm of scale bar)

### Example 2

In manufacturing Au nanoparticles, in order to determine effect of gold salt, a different gold salt was used. A solution of 2.46×10⁻⁴ mol (AuCl₃ 75 mg) of gold salt and 826 μl of octylamine dissolved in 25 mL of toluene was added to the above platinum seed solution. 0.20 M of hydrazine was added to grow up to Au nanoparticles

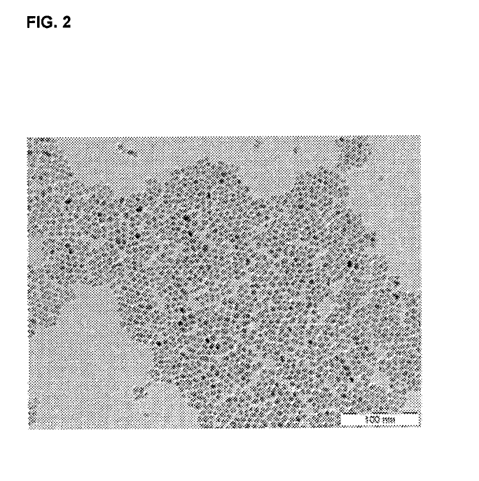

Au nanoparticles prepared had a size of less than 10 nm. However, much of Au particles was precipitated during the manufacturing process and the gold salt solution used to grow up to nanoparticles was unstable (FIG. 2, 100 nm of scale bar)

### Example 3

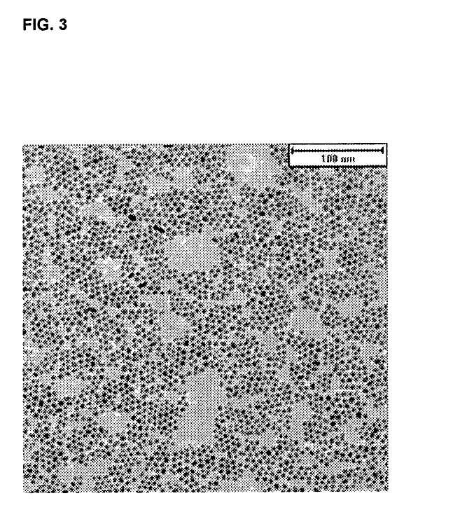

In manufacturing Au nanoparticles, in order to solve a dispersion problem when octylamine is used and stability problem of the growth solution, experiment was performed by controlling a surfactant. A solution of 2.46×10⁻⁴ mol (HAuCl₄ 97 mg) of gold salt and 925 mg of dodecylamine dissolved in 25 mL of toluene was added into the above-prepared platinum seed solution. 0.20 M of hydrazine was added to grow up to Au nanoparticles. As shown in a TEM image of Au nanoparticles, it is noted that Au nanoparticles having a size of less than 10 nm is produced stably. Participation of Au nanoparticles during the manufacturing process was minimized and there was no participation during the centrifugal separation process at a rate of 3,500 rpm for 15 mins and Au nanoparticles was well dispersed stably (FIG. 3).

While it has been described with reference to particular embodiments, it is to be appreciated that various changes and modifications may be made by those skilled in the art without departing from the spirit and scope of the embodiment herein, as defined by the appended claims and their equivalents.

What is claimed is:

1. Au nanoparticles comprising 0.001-50 mol % of platinum seed with respect to the total particles, in which the Au nanoparticles are grown from the platinum seed produced in a non-aqueous solvent.

2. Au nanoparticles of claim 1, wherein the platinum seed is included by 0.1-20 mol % with respect to the total particles.

3. Au nanoparticles of claim 1, wherein the Au nanoparticles is prepared by a method comprising: preparing a solution by adding a monosurfactant into a non-aqueous solvent; preparing a platinum seed solution by adding platinum salt into the solution; and adding gold salt in the platinum seed solution.

4. A method for manufacturing Au nanoparticles comprising:
preparing a solution by adding a monosurfactant into a non-aqueous solvent;
preparing a platinum seed solution by adding platinum salt into the solution; and
adding gold salt in the platinum seed solution.

5. The method of claim 4, wherein the non-aqueous solvent is at least one selected from the group consisting of toluene, benzene, chlorobenzene, dichlorobenzene, xylene and a mixture thereof.

6. The method of claim 4, wherein the monosurfactant is added by 10-50 equivalents per 1 equivalent of the gold salt and the platinum salt to form the platinum seed is added by 1/10-1/1000 equivalents per 1 equivalent of the gold salt.

7. The method of claim 4, wherein the monosurfactant is a C8-C20 amine.

8. The method of claim 4, wherein the monosurfactant is selected from the group consisting of octylamine, dodecylamine, and oleylamine.

9. The method of claim 4, wherein the platinum salt is selected from the group consisting of chloroplatinic acid(H₂PtCl₆) and platinum chloride(PtCl₄).

10. The method of claim 4, wherein the gold salt is at least one selected from the group consisting of gold chloride (AuCl₃), hydrogen tetrachloroaurate (HAuCl₄), hydrogen tetrabromoaurate (HAuBr₄), and gold acetylacetonate.

11. The method of claim 4, wherein the platinum seed solution is reacted at 25-50 L for 5 mins to 2 hrs after adding the platinum salt.

12. The method of claim 4, wherein the Au nanoparticles is reacted at 25-50 L for 1 min to 2 hrs after adding the gold salt.

13. A nano colloid solution comprising Au nanoparticles of claim 1.

14. A nano ink comprising Au nanoparticles of claim 1.

15. An interconnection pad comprising Au nanoparticles of claim 1.

16. A biosensor comprising Au nanoparticles of claim 1.

17. A nano colloid solution comprising Au nanoparticles of claim 3.

18. A nano ink comprising Au nanoparticles of claim 3.

19. An interconnection pad comprising Au nanoparticles of claim 3.

20. A biosensor comprising Au nanoparticles of claim 3.
